(19) United States
(12) Patent Application Publication
(10) Pub. No.: US 2024/0210761 A1
(43) Pub. Date: Jun. 27, 2024

(54) DISPLAY PANEL AND DISPLAY SYSTEM

(71) Applicant: TCL China Star Optoelectronics Technology Co., Ltd., Shenzhen, Guangdong (CN)

(72) Inventor: Bo HAI, Shenzhen, Guangdong (CN)

(73) Assignee: TCL China Star Optoelectronics Technology Co., Ltd., Shenzhen, Guangdong (CN)

(21) Appl. No.: 17/795,044

(22) PCT Filed: Jul. 19, 2022
(86) PCT No.: PCT/CN2022/106488

§ 371 Date: Jul. 25, 2022

(30) Foreign Application Priority Data
May 31, 2022 (CN) 202210612820.0

(51) Int. Cl. G02F 1/13363; G02F 1/1335

(52) U.S. Cl. CPC G02F 1/133638; G02F 1/133531; G02F 2201/50; G02F 2413/02

(57) ABSTRACT

A display system includes a display panel and a pair of glasses. The display panel includes a display panel body, a first polarizer disposed on a non-display side of the display panel body, and a first wave plate disposed on a display side of the display panel body. The display side is opposite to the non-display side. The pair of glasses includes a second polarizer and a second wave plate. The second polarizer includes a polarizing layer. The second wave plate is disposed on a side of the polarizing layer away from eyes. The pair of glasses is configured to present images displayed by the display panel.

### FIELD OF INVENTION

The present disclosure relates to the field of display, particularly to a display panel and a display system.

### BACKGROUND

With wide application of display panels, various display devices continue to appear. For example, mobile phones, tablets, televisions, etc. have been widely used in daily life. However, in public places, for example, when automatic teller machines and other occasions that need to protect privacy are used, data information on display panels is easily seen by other people, and private information is easily leaked. Therefore, it is necessary to develop a new type of display that protects privacy.

However, a dark state and a low grayscale of a conventional privacy-preserving display panel are very bright, so a contrast ratio is severely reduced, resulting in a serious reduction in a display effect, which needs to be improved.

### SUMMARY OF DISCLOSURE

The present disclosure provides a display panel and a display system, which can solve problems that a dark state and a low grayscale of a conventional privacy-preserving display panel are very bright, a contrast ratio is severely reduced, and a display effect is severely reduced.

The present disclosure provides a display panel, which comprises a display panel body, a first polarizer, and a first wave plate. The display panel body comprises a display side and a non-display side arranged oppositely. The first polarizer is disposed on the non-display side. The first wave plate is disposed on the display side. The first wave plate is a (½N+¼) wave plate, and N is a positive integer. The display panel is configured to present images in cooperation with a pair of glasses comprising a second polarizer and a second wave plate.

Optionally, in some embodiments, the first wave plate is directly attached to a surface of the display panel body on the display side, and a side of the first wave plate away from the display panel body is not provided with another polarizer.

Optionally, in some embodiments, an acute angle between an absorption axis of the first polarizer and an optical axis of the first wave plate is greater than or equal to 40 degrees and less than or equal to 50 degrees.

Optionally, in some embodiments, the acute angle between the absorption axis of the first polarizer and the optical axis of the first wave plate is equal to 45 degrees.

Optionally, in some embodiments, the display panel is a liquid crystal display panel, and the display panel body is a liquid crystal display panel body.

The present disclosure further provides a display system, which comprises a display panel and a pair of glasses. The display panel comprises a display panel body, a first polarizer disposed on a non-display side of the display panel body, and a first wave plate disposed on a display side of the display panel body. The display side is opposite to the non-display side. The pair of glasses comprises a second polarizer and a second wave plate. The second polarizer comprises a polarizing layer. The second wave plate is disposed on a side of the polarizing layer away from eyes. The pair of glasses is configured to present images displayed by the display panel.

Optionally, in some embodiments, the first wave plate and the second wave plate are respectively a (½N+¼) wave plate and a (½M+¼) wave plate, and N and M are both positive integers.

Optionally, in some embodiments, an acute angle between an absorption axis of the first polarizer and an optical axis of the first wave plate is greater than or equal to 40 degrees and less than or equal to 50 degrees.

Optionally, in some embodiments, an acute angle between an absorption axis of the second polarizer and an optical axis of the second wave plate is greater than or equal to 40 degrees and less than or equal to 50 degrees.

Optionally, in some embodiments, when the pair of glasses faces the display panel, an optical axis of the first wave plate and an optical axis of the second wave plate are perpendicular to each other, and an acute angle between the optical axis of the first wave plate and an absorption axis of the first polarizer is 45 degrees.

Optionally, in some embodiments, when the pair of glasses faces the display panel, the absorption axis of the first polarizer is arranged in a first direction, an absorption axis of the second polarizer is arranged in a second direction, the first direction is perpendicular to the second direction, an angle between the optical axis of the first wave plate and the first direction is 45 degrees, and an angle between the optical axis of the second wave plate and the first direction is 135 degrees.

Optionally, in some embodiments, when the pair of glasses faces the display panel, the absorption axis of the first polarizer is arranged in a first direction, an absorption axis of the second polarizer is arranged in a second direction, the first direction is perpendicular to the second direction, an angle between the optical axis of the first wave plate and the first direction is 135 degrees, and an angle between the optical axis of the second wave plate and the first direction is 45 degrees.

Optionally, in some embodiments, when the pair of glasses faces the display panel, an absorption axis of the second polarizer is arranged in a first direction, the absorption axis of the first polarizer is arranged in a second direction, the first direction is perpendicular to the second direction, an angle between the optical axis of the first wave plate and the first direction is 45 degrees, and an angle between the optical axis of the second wave plate and the first direction is 135 degrees.

Optionally, in some embodiments, when the pair of glasses faces the display panel, an absorption axis of the second polarizer is arranged in a first direction, the absorption axis of the first polarizer is arranged in a second direction, the first direction is perpendicular to the second direction, an angle between the optical axis of the first wave plate and the first direction is 135 degrees, and an angle between the optical axis of the second wave plate and the first direction is 45 degrees.

Optionally, in some embodiments, the second wave plate is located in the second polarizer.

Optionally, in some embodiments, the display system further comprises a first protective layer and a second protective layer. The first protective layer is disposed on a side of the first wave plate away from the display panel body. The second protective layer is disposed on a side of the second wave plate away from the polarizing layer of the second polarizer.

Optionally, in some embodiments, an acute angle between an absorption axis of the first polarizer and an optical axis of the first wave plate is equal to 45 degrees.

Optionally, in some embodiments, the first wave plate and the second wave plate are made of at least one of cyclic polyolefin and triacetate.

Optionally, in some embodiments, the display panel is a liquid crystal display panel, and the display panel body is a liquid crystal display panel body.

Optionally, in some embodiments, the liquid crystal display panel is a vertical alignment liquid crystal display panel or a fringe field switching liquid crystal display panel.

The present disclosure provides a display panel and a display system. The display panel comprises a display panel body, a first polarizer, and a first wave plate. The display panel body comprises a display side and a non-display side arranged oppositely. The first polarizer is disposed on the non-display side. The first wave plate is disposed on the display side. The first wave plate is a (½N+¼) wave plate, and N is a positive integer. The display panel is configured to present images in cooperation with a pair of glasses comprising a second polarizer and a second wave plate. In the present disclosure, the first wave plate is disposed on the display side of the display panel body, and the first wave plate is a (½N+¼) wave plate. The display panel is configured to present images in cooperation with the pair of glasses comprising the second polarizer and the second wave plate. In the pair of glasses matched with the display panel, a light emitted by the display panel is converted into a circularly polarized light after passing through the first wave plate, the circularly polarized light is converted into a linearly polarized light by the second wave plate of the pair of glasses, and the linearly polarized light can pass through the second polarizer to present an image. The second wave plate of the pair of glasses and the first wave plate of the display panel can present good images without angle matching. Therefore, when a user uses the pair of glasses to view the display panel, even if the pair of glasses is skewed or shifted, the user can still see good images. This ensures that brightness of a dark state and a low grayscale of the display panel remains very low, thereby avoiding a reduction of a contrast ratio and a serious reduction of a display effect. Furthermore, because the second polarizer is disposed in the pair of glasses, only the user of the display panel can see the image clearly when he wears the pair of glasses, thereby preventing peeping and protecting the user's private information.

### BRIEF DESCRIPTION OF DRAWINGS

In order to more clearly illustrate technical solutions in embodiments of the present disclosure, a brief description of accompanying drawings used in a description of the embodiments will be given below. Obviously, the accompanying drawings in the following description are merely some embodiments of the present disclosure. For those skilled in the art, other drawings may be obtained from these accompanying drawings without creative labor.

FIG. 1 is a first schematic cross-sectional structure diagram of a display panel according to an embodiment of the present disclosure.

FIG. 2 is a schematic diagram of a use state of a display system according to an embodiment of the present disclosure.

FIG. 3 is a first schematic cross-sectional structure diagram of the display panel and a pair of glasses of the display system according to an embodiment of the present disclosure.

FIG. 4 is a schematic cross-sectional structure diagram showing first cooperation between the display panel and the pair of glasses of the display system according to an embodiment of the present disclosure.

FIG. 5 is a schematic cross-sectional structure diagram showing second cooperation between the display panel and the pair of glasses of the display system according to an embodiment of the present disclosure.

FIG. 6 is a schematic cross-sectional structure diagram showing third cooperation between the display panel and the pair of glasses of the display system according to an embodiment of the present disclosure.

FIG. 7 is a schematic cross-sectional structure diagram showing fourth cooperation between the display panel and the pair of glasses of the display system according to an embodiment of the present disclosure.

FIG. 8 is a second schematic cross-sectional structure diagram of the display panel and the pair of glasses of the display system according to an embodiment of the present disclosure.

FIG. 9 is a third schematic cross-sectional structure diagram of the display panel and the pair of glasses of the display system according to an embodiment of the present disclosure.

FIG. 10 is a fourth schematic cross-sectional structure diagram of the display panel and the pair of glasses of the display system according to an embodiment of the present disclosure.

### DETAILED DESCRIPTION

Technical solutions in embodiments of the present disclosure will be clearly and completely described below in conjunction with accompanying drawings in the embodiments of the present disclosure. It is apparent that the described embodiments are merely a part of the embodiments of the present disclosure and not all embodiments. All other embodiments obtained by those skilled in the art based on the embodiments of the present disclosure without creative labor are within claimed scope of the present disclosure. In addition, it should be understood that specific embodiments described herein are only used to illustrate and explain the present invention, and are not used to limit the present invention. In the present disclosure, unless otherwise stated, directional terms used herein specifically indicate directions of the accompanying drawings. For example, directional terms “upper” and “lower” generally refer to upper and lower positions of a device in actual use or working conditions, and directional terms “inside” and “outside” refer to positions relative to a profile of the device.

The present disclosure provides a display panel. The display panel comprises a display panel body, a first polarizer, and a first wave plate. The display panel body comprises a display side and a non-display side arranged oppositely. The first polarizer is disposed on the non-display side. The first wave plate is disposed on the display side. The first wave plate is a (½N+¼) wave plate, and N is a positive integer. The display panel is configured to present images in cooperation with a pair of glasses comprising a second polarizer and a second wave plate. The present disclosure further provides a display system. Each of them will be described in detail below. It should be noted that a description order of the following embodiments is not intended to limit a preferred order of the embodiments.

### First Embodiment

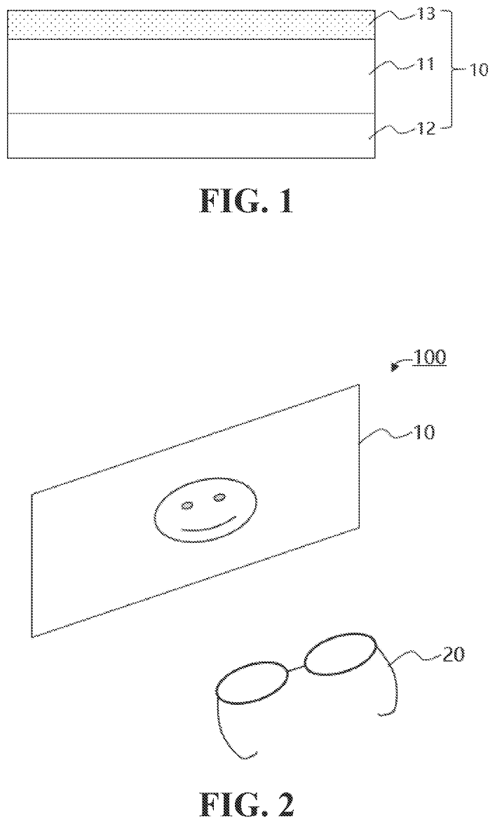

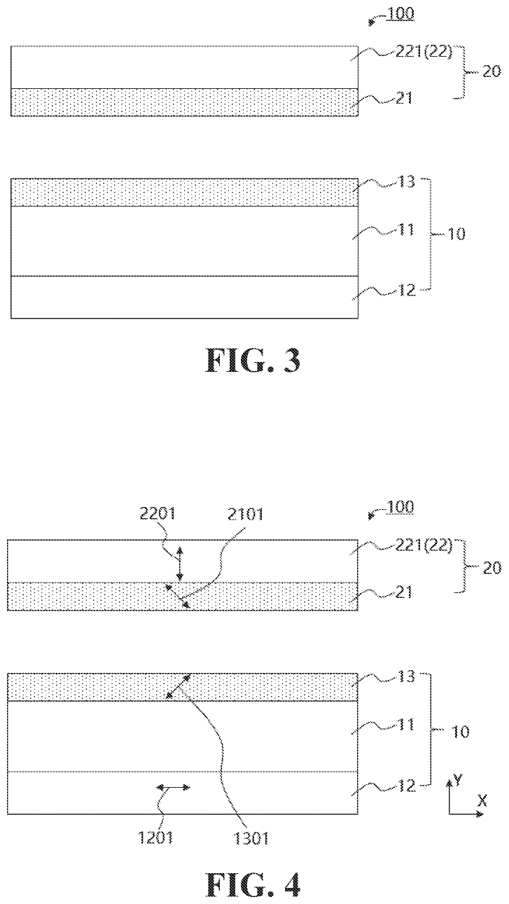

Please refer to FIG. 1 to FIG. 3. FIG. 1 is a first schematic cross-sectional structure diagram of a display panel 10 according to an embodiment of the present disclosure. FIG. 2 is a schematic diagram of a use state of a display system 100 according to an embodiment of the present disclosure. FIG. 3 is a first schematic cross-sectional structure diagram of the display panel 10 and a pair of glasses 20 of the display system 100 according to an embodiment of the present disclosure. FIG. 2 is a schematic diagram of a state of viewing an image displayed by the display panel 10 or operation of the display system 100. FIG. 3 illustrates cross-sectional structures of the pair of glasses 20 and the display panel 10. In order to intuitively illustrate a cooperation relationship between the display panel 10 and the pair of glasses 20 in a working state, in FIG. 3, the cross-sectional structure of the pair of glasses 20 and the cross-sectional structure of the display panel 10 are shown in a same figure according to a light emission sequence.

The present disclosure provides a display panel 10. The display panel 10 comprises a display panel body 11, a first polarizer 12, and a first wave plate 13. The display panel body 11 comprises a display side and a non-display side arranged oppositely. The first polarizer 12 is disposed on the non-display side of the display panel body 11. The first wave plate 13 is disposed on the display side of the display panel body 11. The first wave plate 13 is a (½N+¼) wave plate, and N is a positive integer. The display panel 10 is configured to present images in cooperation with a pair of glasses 20 comprising a second polarizer 22 and a second wave plate 21.

Specifically, this embodiment provides the display panel 10. In order to describe a structure and functions of the display panel 10 in detail and intuitively, please refer to relevant schematic diagrams of the display system 100 provided in the following embodiments. Please refer to FIG. 1, FIG. 2, and FIG. 3 at the same time to understand the structure and the functions of the display panel 10 in this embodiment.

Specifically, the display panel 10 is configured to present images in cooperation with the pair of glasses 20 comprising the second polarizer 22 and the second wave plate 21. That is, the display panel 10 is used in combination with the pair of glasses 20 to display or view images. When using the pair of glasses 20, a user can view images displayed by the display panel 10 to obtain required information, while other people who do not wear the pair of glasses 20 cannot see correct image information displayed by the display panel 10, thereby realizing anti-peep display.

Specifically, the display side refers to a side on which the display panel 10 or the display panel body 11 displays image information, that is, a side on which the user views the display panel 10. For example, the display side refers to a side of the first wave plate 13 away from the display panel body 11 in FIG. 1.

Specifically, the non-display side refers to a side away from the side on which the display panel 10 or the display panel body 11 displays image information, that is, a side away from the side on which the user views the display panel 10. For example, the non-display side refers to a side of the first polarizer 12 away from the display panel body 11 in FIG. 1.

Specifically, the display panel 10 may be a liquid crystal display panel, and the display panel body 11 may be a liquid crystal display panel body. The liquid crystal display panel body may comprise a color filter substrate, an array substrate, and a liquid crystal layer sandwiched between the color filter substrate and the array substrate.

Specifically, the display panel 10 comprises the display panel body 11, the first polarizer 12, and the first wave plate 13. The first polarizer 12 is disposed on the non-display side of the display panel body 11. The first wave plate 13 is disposed on the display side of the display panel body 11. That is, the display panel body 11 is sandwiched between the first polarizer 12 and the first wave plate 13, and the side of the first wave plate away from the display panel body 11 is the display side.

Specifically, the first wave plate 13 is a (½N+¼) wave plate, and N is a positive integer. The first wave plate 13 is a three-quarter wave plate. The first wave plate 13 is a wave plate having a same function as a three-quarter wave plate, which will be described in detail below.

In some embodiments, the first wave plate 13 is directly attached to a surface of the display panel body 11 on the display side, and the side of the first wave plate 13 away from the display panel body 11 is not provided with another polarizer.

Specifically, the display panel 10 comprises only the first polarizer 12 and the first wave plate 13, and no polarizers other than the first wave plate 13 are provided on the display side of the display panel body 11.

In this embodiment, the first wave plate 13 is disposed on the display side of the display panel body. The display panel 10 is configured to present images in cooperation with the pair of glasses 20 comprising the second polarizer 22 and the second wave plate 21. In the pair of glasses 20 matched with the display panel 10, a light emitted by the display panel 10 is converted into a circularly polarized light after passing through the first wave plate 13, the circularly polarized light is converted into a linearly polarized light by the second wave plate 21 of the pair of glasses 20, and the linearly polarized light can pass through the second polarizer 22 to present an image. The second wave plate 21 of the pair of glasses 20 and the first wave plate 13 of the display panel 10 can present good images without angle matching. Therefore, when a user uses the pair of glasses 20 to view the display panel 10, even if the pair of glasses 20 is skewed or shifted, the user can still see good images. This ensures that brightness of a dark state and a low grayscale of the display panel 10 remains very low, thereby avoiding a reduction of a contrast ratio and a serious reduction of a display effect. Furthermore, because the second polarizer 22 is disposed in the pair of glasses 20, only the user of the display panel 10 can see the image clearly when he wears the pair of glasses 20, thereby preventing peeping and protecting the user's private information.

### Second Embodiment

Please refer to FIG. 2 to FIG. 3, this embodiment provides a display system 100. The display system 100 comprises a display panel 10 and a pair of glasses 20. Any one of the display panels 10 in the first embodiment may be used in the display system 100 of this embodiment, which can realize anti-peep display and have effects of low dark-state brightness, low low-grayscale brightness, high contrast ratio, and high image quality. However, any one of the display panels 10 in the first embodiment is not a limitation on the display panel 10 included in the display system 100 in this embodiment.

This embodiment provides the display system 100. The display system 100 comprises the display panel 10 and the pair of glasses 20. The display panel 10 comprises a display panel body 11, a first polarizer 12 disposed on a non-display side of the display panel body 11, and a first wave plate 13 disposed on a display side of the display panel body 11. The display side is opposite to the non-display side. The pair of glasses 20 comprises a second polarizer 22 and a second wave plate 21. The second polarizer 22 comprises a polarizing layer 221. The second wave plate 21 is disposed on a far-eye side of the polarizing layer 221. The pair of glasses 20 is configured to present images displayed by the display panel 10.

Specifically, the display system 100 comprises the display panel 10 and the pair of glasses 20. The pair of glasses 20 is configured for presenting or viewing images displayed by the display panel 10.

Specifically, a near-eye side refers to a side close to the user's eyes or a side away from the display panel 10 when the user wears the pair of glasses 20 to view images displayed by the display panel 10.

Specifically, the far-eye side refers to a side away from the user's eyes or a side close to the display panel 10 when the user wears the pair of glasses 20 to view images displayed by the display panel 10.

Specifically, the display panel 10 comprises the display panel body 11, the first polarizer 12 disposed on the non-display side of the display panel body 11, and the first wave plate 13 disposed on the display side of the display panel body 11. That is, the display panel body 11 is sandwiched between the first polarizer 12 and the first wave plate 13.

Specifically, the pair of glasses 20 comprises the second polarizer 22 and the second wave plate 21. The second polarizer 22 comprises the polarizing layer 221. The second wave plate 21 is disposed on the far-eye side of the polarizing layer 221. That is, when the user wears the pair of glasses 20 to view images displayed by the display panel 10, the second wave plate 21 is closer to the display panel 10 than the polarizing layer 221.

Specifically, because the second polarizer 22 is disposed in the pair of glasses 20, only the user of the display panel 10 can see images clearly by wearing the glasses 20, and bystanders cannot watch display images presented by the display system, thereby preventing peeping.

In some embodiments, the first wave plate 13 and the second wave plate 21 are respectively a (½N+¼) wave plate and a (½M+¼) wave plate, and N and M are both positive integers.

Specifically, the first wave plate 13 is a (½N+¼) wave plate, the second wave plate 21 is a (½M+¼) wave plate, and both N and M are positive integers.

Specifically, the first wave plate 13 and the second wave plate 21 are both three-quarter wave plates. Both the first wave plate 13 and the second wave plate 21 have a same function as a three-quarter wave plate.

Specifically, the first wave plate 13 and the second wave plate 21 may have different thicknesses, and N and M may be different values.

Specifically, the first wave plate 13 and the second wave plate 21 cooperate with each other, so that after a light or natural light passes through the first polarizer 12, the display panel body 11, the first wave plate 13, and the second wave plate 21 in sequence, the light or natural light can normally pass through the second polarizer 22 or be normally blocked by the second polarizer 22. Therefore, when the user uses the pair of glasses 20 to view the display panel 10, even if the pair of glasses 20 is skewed or shifted, the user can still see good images. This ensures that brightness of a dark state and a low grayscale of the display panel 10 remains very low, thereby avoiding a reduction of a contrast ratio and a serious reduction of a display effect. Furthermore, because the second polarizer 22 is disposed in the pair of glasses 20, only the user of the display panel 10 can see the image clearly when he wears the pair of glasses 20, thereby preventing peeping.

In some embodiments, an acute angle between an absorption axis of the first polarizer 12 and an optical axis of the first wave plate 13 is greater than or equal to 40 degrees and less than or equal to 50 degrees.

Specifically, the absorption axis of the first polarizer 12 is matched with the optical axis of the first wave plate 13, so that the first wave plate 13 can convert a linearly polarized light passing through the first polarizer 12 and the display panel body 11 in sequence into a circularly polarized light. A matching angle between the absorption axis of the first polarizer 12 and the optical axis of the first wave plate 13 is an acute angle greater than or equal to 40 degrees and less than or equal to 50 degrees.

Specifically, the acute angle between the absorption axis of the first polarizer 12 and the optical axis of the first wave plate 13 is greater than or equal to 40 degrees and less than or equal to 50 degrees. That is, an angle between the absorption axis of the first polarizer 12 and the optical axis of the first wave plate 13 is 40 degrees to 50 degrees (comprising 40 degrees and 50 degrees), or the angle between the absorption axis of the first polarizer 12 and the optical axis of the first wave plate 13 is 130 degrees to 140 degrees (comprising 130 degrees and 140 degrees).

Furthermore, preferably, the acute angle between the absorption axis of the first polarizer 12 and the optical axis of the first wave plate 13 is equal to 45 degrees. That is, the angle between the absorption axis of the first polarizer 12 and the optical axis of the first wave plate 13 is equal to 45 degrees or 135 degrees, so that the first wave plate 13 can better convert light.

In some embodiments, an acute angle between an absorption axis of the second polarizer 22 and an optical axis of the second wave plate 21 is greater than or equal to 40 degrees and less than or equal to 50 degrees.

Specifically, the absorption axis of the second polarizer 22 is matched with the optical axis of the second wave plate 21, so that a polarized light passing through the display panel 10 and the second wave plate 21 in sequence can pass through the polarizing layer of the second polarizer 22. A matching angle between the absorption axis of the second polarizer 22 and the optical axis of the second wave plate 21 is an acute angle greater than or equal to 40 degrees and less than or equal to 50 degrees.

Specifically, the acute angle between the absorption axis of the second polarizer 22 and the optical axis of the second wave plate 21 is greater than or equal to 40 degrees and less than or equal to 50 degrees. That is, an angle between the absorption axis of the second polarizer 22 and the optical axis of the second wave plate 21 is 40 degrees to 50 degrees (comprising 40 degrees and 50 degrees), or the angle between the absorption axis of the second polarizer 22 and the optical axis of the second wave plate 21 is 130 degrees to 140 degrees (comprising 130 degrees and 140 degrees).

Furthermore, preferably, the acute angle between the absorption axis of the second polarizer 22 and the optical axis of the second wave plate 21 is equal to 45 degrees. That is, the angle between the absorption axis of the second polarizer 22 and the optical axis of the second wave plate 21 is equal to 45 degrees or 135 degrees, so that the second wave plate 21 can better convert light.

Specifically, it should be noted that the display side of the display panel body 11 is provided with the first wave plate 13, and the first wave plate 13 can convert a light passing through the display panel body 11 into a circularly polarized light. Then, the second wave plate 21 in the pair of glasses 20 converts the circularly polarized light passing through the display panel 10 into a linearly polarized light. The linearly polarized light is then transmitted through the polarizing layer 221 of the second polarizer 22 to reach human eyes or present an image. Therefore, as long as the user wears the pair of glasses 20, the pair of glasses 20 may be rotated or worn at any angle, and images on the display panel 10 can be viewed or presented. Other people who do not wear the pair of glasses cannot see the images on the display panel 10.

Furthermore, when the pair of glasses 20 faces the display panel 10, the absorption axis of the first polarizer 12 and the absorption axis of the second polarizer 22 are perpendicular to each other. That is, when the user wears the pair of glasses 20 to view images displayed by the display panel 10, the absorption axis of the first polarizer 12 and the absorption axis of the second polarizer 22 are just perpendicular to each other. The user may usually be in this viewing state.

Specifically, FIG. 2 illustrates that the pair of glasses 20 faces the display panel 10.

Specifically, a case where the pair of glasses 20 faces the display panel 10 means that the absorption axis of the first polarizer 12 and the absorption axis of the second polarizer 22 are perpendicular to each other.

Specifically, when the pair of glasses 20 faces the display panel 10, the absorption axes of the first polarizer 12 and the second polarizer 22 are perpendicular to each other. The user may usually be in this viewing state, so an angle setting relationship of the first polarizer 12, the first wave plate 13, the second polarizer 22, and the second wave plate 21 is described with the case where the pair of glasses 20 faces the display panel 10.

Specifically, furthermore, in some embodiments, the display panel 10 is not provided with another polarizer on the display side of the display panel body 11. More specifically, the display panel 10 comprises only the first polarizer 12 and does not comprise polarizers other than the first polarizer 12.

It should be noted that the following embodiments are described with preferred implementation in which the acute angle between the absorption axis of the first polarizer 12 and the optical axis of the first wave plate 13 is equal to 45 degrees, and the acute angle between the absorption axis of the second polarizer 22 and the optical axis of the second wave plate 21 is equal to 45 degrees.

In some embodiments, when the pair of glasses 20 faces the display panel 10, the optical axis of the first wave plate 13 and the optical axis of the second wave plate 21 are perpendicular to each other, and the acute angle between the optical axis of the first wave plate 13 and the absorption axis of the first polarizer 12 is 45 degrees.

Specifically, a collocation, cooperation, or adaptation relationship of the first polarizer 12, the first wave plate 13, the second wave plate 21, and the second polarizer 22 is that the absorption axis of the first polarizer 12 and the absorption axis of the second polarizer 22 are perpendicular to each other, and the optical axis of the first wave plate 13 and the optical axis of the second wave plate 21 are perpendicular to each other, and the acute angle between the optical axis of the first wave plate 13 and the absorption axis of the first polarizer 12 is 45 degrees.

Specifically, the acute angle of the optical axis of the first wave plate 13 and the absorption axis of the first polarizer 12 is 45 degrees, and an obtuse angle between the optical axis of the first wave plate 13 and the absorption axis of the first polarizer 12 is 135 degrees.

Specifically, the first polarizer 12, the first wave plate 13, the second wave plate 21, and the second polarizer 22 cooperate together, so that the display panel 10 has effects of low dark-state brightness, low low-grayscale brightness, high contrast ratio, and high image quality when viewed by the user, and realizes anti-peep function.

### Third Embodiment

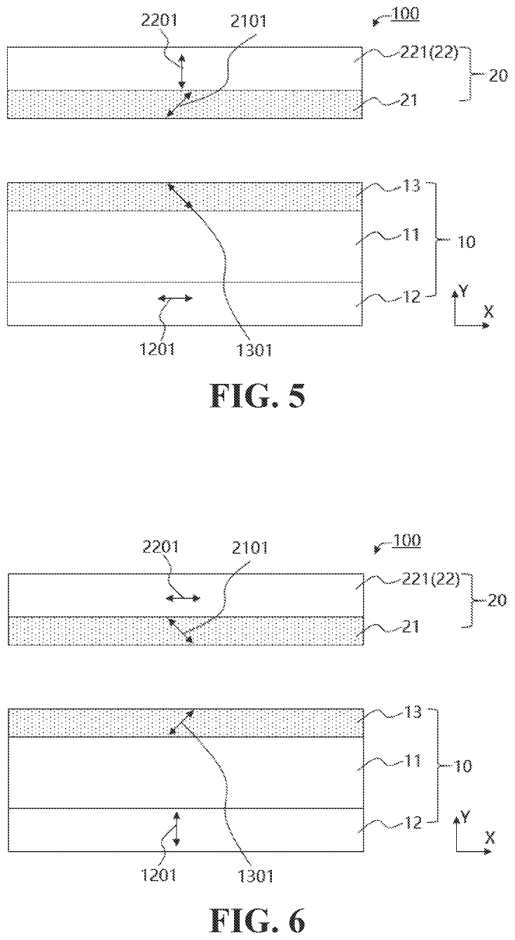

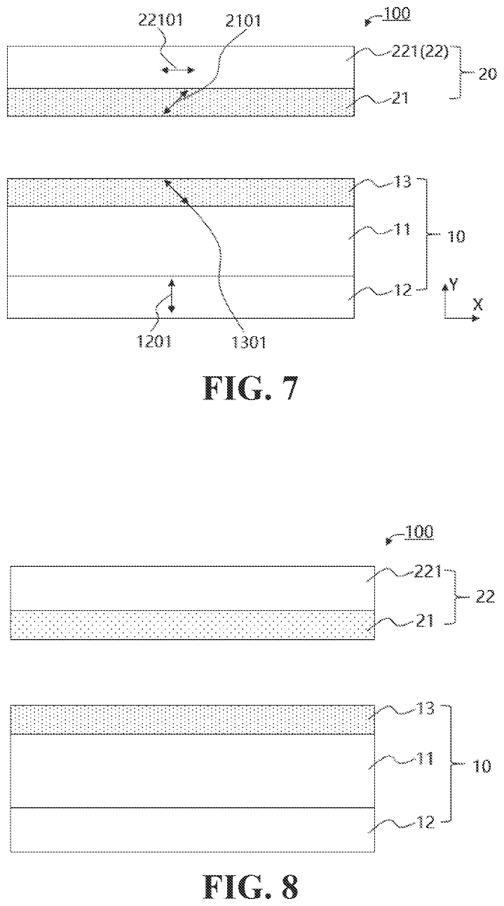

Please refer to FIG. 4 to FIG. 7. FIG. 4 is a schematic cross-sectional structure diagram showing first cooperation between the display panel 10 and the pair of glasses 20 of the display system 100 according to an embodiment of the present disclosure. FIG. 5 is a schematic cross-sectional structure diagram showing second cooperation between the display panel 10 and the pair of glasses 20 of the display system 100 according to an embodiment of the present disclosure. FIG. 6 is a schematic cross-sectional structure diagram showing third cooperation between the display panel 10 and the pair of glasses 20 of the display system 100 according to an embodiment of the present disclosure. FIG. 7 is a schematic cross-sectional structure diagram showing fourth cooperation between the display panel 10 and the pair of glasses 20 of the display system 100 according to an embodiment of the present disclosure. FIG. 4 to FIG. 7 illustrate cross-sectional structures of the pair of glasses 20 and the display panel 10. In order to intuitively illustrate a working state of the display system 100 and a cooperation relationship between the display panel 10 and the pair of glasses 20, in FIG. 4 to FIG. 7, the cross-sectional structure of the pair of glasses 20 and the cross-sectional structure of the display panel 10 are shown in a same figure according to a light emission sequence. For convenience of illustrating directions of an absorption axis of each polarizer and an optical axis of each wave plate, FIG. 4 to FIG. 7 show a first direction X and a second direction Y. The first direction X and the second direction Y are set for the absorption axis of each polarizer and the optical axis of each wave plate, not for the cross-sectional structures of the display panel 10 and the pair of glasses 20. FIG. 4 to FIG. 7 illustrate that the absorption axis of the first polarizer 12 is a first absorption axis 1201, the absorption axis of the second polarizer 22 is a second absorption axis 2201, an optical axis of the first wave plate 13 is a first optical axis 1301, and the optical axis of the second wave plate 21 is 2101.

This embodiment is same as or similar to the second embodiment, and a difference lies in that various matching states of the display panel 10 and the pair of glasses 20 are further described.

In some embodiments, as shown in FIG. 4, when the pair of glasses 20 faces the display panel 10, the absorption axis of the first polarizer 12 is arranged in the first direction X, the absorption axis of the second polarizer 22 is arranged in the second direction Y. The first direction X is perpendicular to the second direction Y. An angle between the optical axis of the first wave plate 13 and the first direction X is 45 degrees, and an angle between the optical axis of the second wave plate 21 and the first direction X is 135 degrees.

Specifically, for example, the first direction X is a 0-degree direction, and the second direction Y is a 90-degree direction. The first absorption axis 1201 of the first polarizer 12 is arranged in the 0-degree direction. The second absorption axis 2201 of the second polarizer 22 is arranged in the 90-degree direction. The first optical axis 1301 of the first wave plate 13 is arranged in a 45-degree direction. The second optical axis 2101 of the second wave plate 21 is arranged in a 135-degree direction.

In some embodiments, as shown in FIG. 5, when the pair of glasses 20 faces the display panel 10, the absorption axis of the first polarizer 12 is arranged in the first direction X, the absorption axis of the second polarizer 22 is arranged in the second direction Y. The first direction X is perpendicular to the second direction Y. The angle between the optical axis of the first wave plate 13 and the first direction X is 135 degrees, and the angle between the optical axis of the second wave plate 21 and the first direction X is 45 degrees.

Specifically, for example, the first direction X is the 0-degree direction, and the second direction Y is the 90-degree direction. The first absorption axis 1201 of the first polarizer 12 is arranged in the 0-degree direction. The second absorption axis 2201 of the second polarizer 22 is arranged in the 90-degree direction. The first optical axis 1301 of the first wave plate 13 is arranged in the 135-degree direction. The second optical axis 2101 of the second wave plate 21 is arranged in the 45-degree direction.

In some embodiments, as shown in FIG. 6, when the pair of glasses 20 faces the display panel 10, the absorption axis of the first polarizer 12 is arranged in the second direction Y, the absorption axis of the second polarizer 22 is arranged in the first direction X. The first direction X is perpendicular to the second direction Y. The angle between the optical axis of the first wave plate 13 and the first direction X is 45 degrees, and the angle between the optical axis of the second wave plate 21 and the first direction X is 135 degrees.

Specifically, for example, the first direction X is the 0-degree direction, and the second direction Y is the 90-degree direction. The first absorption axis 1201 of the first polarizer 12 is arranged in the 90-degree direction. The second absorption axis 2201 of the second polarizer 22 is arranged in the 0-degree direction. The first optical axis 1301 of the first wave plate 13 is arranged in the 45-degree direction. The second optical axis 2101 of the second wave plate 21 is arranged in the 135-degree direction.

In some embodiments, as shown in FIG. 7, when the pair of glasses 20 faces the display panel 10, the absorption axis of the first polarizer 12 is arranged in the second direction Y, the absorption axis of the second polarizer 22 is arranged in the first direction X. The first direction X is perpendicular to the second direction Y. The angle between the optical axis of the first wave plate 13 and the first direction X is 135 degrees, and the angle between the optical axis of the second wave plate 21 and the first direction X is 45 degrees.

Specifically, for example, the first direction X is the 0-degree direction, and the second direction Y is the 90-degree direction. The first absorption axis 1201 of the first polarizer 12 is arranged in the 90-degree direction. The second absorption axis 2201 of the second polarizer 22 is arranged in the 0-degree direction. The first optical axis 1301 of the first wave plate 13 is arranged in the 135-degree direction. The second optical axis 2101 of the second wave plate 21 is arranged in the 45-degree direction.

Specifically, through various settings of the absorption axis of each polarizer and the optical axis of each wave plate in this embodiment, various settings of the display panel 10 and the pair of glasses 20 are described, which matches an actual design of a display panel. Therefore, cooperation of the first polarizer 12, the first wave plate 13, the second wave plate 21, and the second polarizer 22 enables the display panel 10 to have effects of low dark-state brightness, low low-grayscale brightness, high contrast ratio, and high image quality when viewed by the user, and realizes anti-peep function.

### Fourth Embodiment

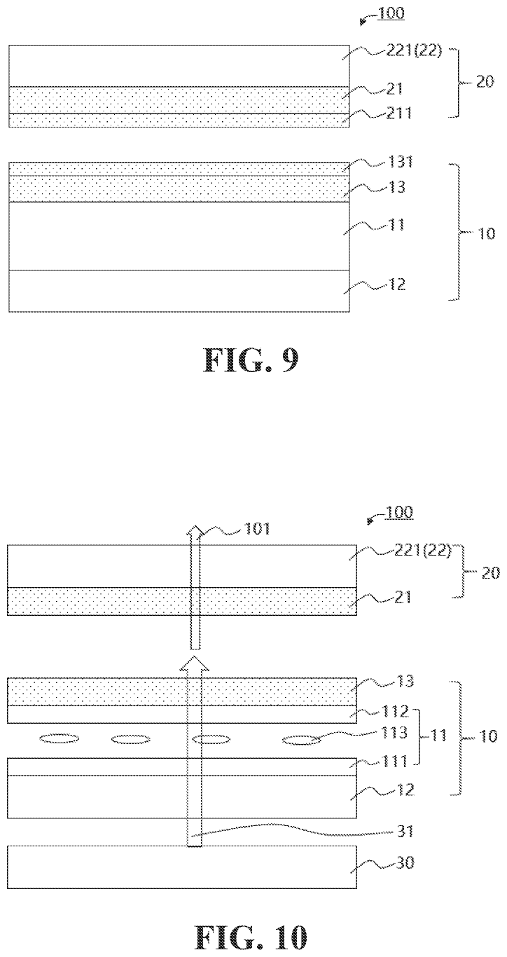

Please refer to FIG. 8 to FIG. 10. FIG. 8 is a second schematic cross-sectional structure diagram of the display panel 10 and the pair of glasses 20 of the display system 100 according to an embodiment of the present disclosure. FIG. 9 is a third schematic cross-sectional structure diagram of the display panel 10 and the pair of glasses 20 of the display system 100 according to an embodiment of the present disclosure. FIG. 10 is a fourth schematic cross-sectional structure diagram of the display panel 10 and the pair of glasses 20 of the display system 100 according to an embodiment of the present disclosure. FIG. 8 to FIG. 10 illustrate cross-sectional structures of the pair of glasses 20 and the display panel 10. In order to intuitively illustrate a working state of the display system 100, in FIG. 8 to FIG. 10, the cross-sectional structure of the pair of glasses 20 and the cross-sectional structure of the display panel 10 are shown in a same figure according to a light emission sequence.

This embodiment is same as or similar to the above embodiments, and a difference lies in that structures of the display panel 10 and/or the pair of glasses 20 are further described. In some embodiments, the second wave plate 21 is located in the second polarizer 22.

Specifically, as shown in FIG. 8, in some embodiments, the pair of glasses 20 comprises a second polarizer 22, and the second polarizer 22 comprises a polarizing layer 221 and a second wave plate 21. Both the polarizing layer 221 and the second wave plate 21 are located in the second polarizer 22, so as to facilitate shipment of polarizer manufacturers and reduce a thickness of the pair of glasses 20.

Furthermore, in some embodiments, the first wave plate 13 and the second wave plate 21 are made of at least one of cyclic polyolefin (COP) and triacetate (TAC).

Specifically, cyclic polyolefin (COP) and triacetate (TAC) are good materials for the first wave plate 13 and the second wave plate 21.

In some embodiments, as shown in FIG. 9, the side of the first wave plate 13 away from the display panel body 11 is provided with a first protective layer 131, and a side of the second wave plate 21 away from the polarizing layer 221 of the second polarizer 22 is provided with a second protective layer 211.

Specifically, the first protective layer 131 is disposed on the side of the first wave plate 13 away from the display panel body 11. The first protective layer 131 has greater hardness to prevent the first wave plate 13 from being damaged such as scratched.

Specifically, the second protective layer 211 is disposed on a far-eye side of the second wave plate 21. The second protective layer 211 has greater hardness to prevent the second wave plate 21 from being damaged such as scratched.

Specifically, furthermore, the first protective layer 131 may be a surface treatment layer of the first wave plate 13, and the second protective layer 211 may be a surface treatment layer of the second wave plate 21.

Specifically, furthermore, the first protective layer 131 and the second protective layer 211 have greater surface hardness. For example, the surface hardness of the first protective layer 131 and the surface hardness of the second protective layer 211 are greater than or equal to 3H.

Furthermore, in some embodiments, as shown in FIG. 10, the display panel 10 may be a liquid crystal display panel, and the display panel body 11 may be a liquid crystal display panel body. In this case, the display panel body 11 may comprise an array substrate 111, a color filter substrate 112, a liquid crystal layer 113 sandwiched between the array substrate 111 and the color filter substrate 112, and other structures. A type of the liquid crystal display panel is not limited herein. For example, the liquid crystal display panel may be a vertical alignment liquid crystal display panel (VA liquid crystal display panel) or a fringe field switching liquid crystal display panel (FSS liquid crystal display panel).

Furthermore, in some embodiments, as shown in FIG. 10, the display system 100 may further comprise a backlight 30. The backlight 30 is disposed on the non-display side of the display panel 10, and the backlight 30 is disposed on the side of the first polarizer 12 away from the display panel body 11. A light emitting process of the display system 100 is as follows. The backlight 30 emits a backlight light 31. The backlight light 31 passes through the first polarizer 12, the display panel body 11, the first wave plate 13, the second wave plate 21, and the second polarizer 22 in sequence and then turns into a display light 101. The display light 101 reaches the human eyes, so the user can see images of the display system 100 or images on the display panel 10.

It should be noted that in some embodiments or any one of the aforementioned embodiments, in the display system 100, as shown in FIG. 10, a transformation process of light is described when the display system 100 or the display panel 10 is in a bright state. A transformation process of the backlight light 31 in the bright state is as follows. The backlight light 31 is converted into a first linearly polarized light through the first polarizer 12. The first linearly polarized light is converted into a left-handed (or right-handed) circularly polarized light through the first wave plate 13. The left-handed (or right-handed) circularly polarized light is converted into a second linearly polarized light through the second wave plate 21. Because the optical axis of the second wave plate 21 and the absorption axis of the second polarizer 22 have a preset angular relationship, the second linearly polarized light can pass through the second polarizer 22, so that the display system 100 or the display panel 10 has an excellent bright state and presents a good image. The second wave plate 21 of the pair of glasses 20 and the first wave plate 13 of the display panel 10 can present good images without angle matching. Therefore, when the user uses the pair of glasses 20 to view the display panel 10, even if the pair of glasses 20 is skewed or shifted, the user can still see good images. This ensures that the brightness of the dark state and the low grayscale of the display panel 10 remains very low, thereby avoiding the reduction of the contrast ratio and the serious reduction of the display effect. Furthermore, because the second polarizer 22 is disposed in the pair of glasses 20, only the user of the display panel 10 can see the image clearly when he wears the pair of glasses 20, thereby preventing peeping and protecting the user's private information.

It should be noted that in the aforementioned embodiment, the backlight light 31 emitted by the backlight 30 comprises visible light with a wavelength of 380 nm to 780 nm. The first wave plate 13 corresponds to a wavelength range of 380 nm to 780 nm, and the second wave plate 21 corresponds to a wavelength range of 380 nm to 780 nm. Preferably, the first wave plate 13 corresponds to a wavelength range of 500 nm to 600 nm, and the second wave plate 21 corresponds to a wavelength range of 500 nm to 600 nm.

It should be noted that Table 1-1 is a comparison data of dark-state brightness and contrast ratio. As shown in Table 1-1 below, a conventional display panel (non-anti-peep display panel) has a dark-state brightness of 0.1 nits and a contrast ratio of 3000. A conventional anti-peep display panel purchased in the market has a dark-state brightness of 10 nits and a contrast ratio of 30. The display system 100 of the present disclosure has a dark-state brightness of 1 nits and a contrast ratio of 300. The display system 100 or the display panel 10 of the present disclosure has a low brightness in the dark state, so the display system 100 or the display panel 10 has a high contrast ratio, and displays a high-quality image.

TABLE 1-1

| | Conventional | Conventional anti- | Display |
|---|---|---|---|
| Name | display panel | peep display panel | system 100 |
| Black-screen | 0.1 | 10 | 1 |
| brightness (nits) | | | |
| Contrast ratio | 3000 | 30 | 300 |

It should be noted that in the display system of any one of the above embodiments, a case (a) is that the pair of glasses 20 and the display panel 10 cooperate to present an image, the absorption axis of the first polarizer 12 and the absorption axis of the second polarizer 22 may form any angle, and the pair of glasses 20 and the display panel 10 can cooperate to present images. A case (b) is that the pair of glasses is worn by the user, the user sits on soles or sits upright, the pair of glasses 20 faces the display panel 10, and the absorption axis of the first polarizer 12 and the absorption axis of the second polarizer 22 are perpendicular to each other. The case (b) is a further limited description of the case (a). However, the user can see the image as long as he wears the pair of glasses 20.

The display panel and the display system provided by the embodiments of the present disclosure are described in detail above. The present disclosure uses specific examples to describe principles and embodiments of the present invention. The above description of the embodiments is only for helping to understand solutions of the present invention and its core ideas. Furthermore, those skilled in the art may make modifications to the specific embodiments and applications according to the ideas of the present invention. In conclusion, the present specification should not be construed as a limitation to the present invention.

What is claimed is:

1. A display panel, comprising:
a display panel body comprising a display side and a non-display side arranged oppositely;
a first polarizer disposed on the non-display side; and
a first wave plate disposed on the display side, wherein the first wave plate is a (½N+¼) wave plate, and N is a positive integer;
wherein the display panel is configured to present images in cooperation with a pair of glasses comprising a second polarizer and a second wave plate.

2. The display panel according to claim 1, wherein the first wave plate is directly attached to a surface of the display panel body on the display side, and a side of the first wave plate away from the display panel body is not provided with another polarizer.

3. The display panel according to claim 2, wherein an acute angle between an absorption axis of the first polarizer and an optical axis of the first wave plate is greater than or equal to 40 degrees and less than or equal to 50 degrees.

4. The display panel according to claim 3, wherein the acute angle between the absorption axis of the first polarizer and the optical axis of the first wave plate is equal to 45 degrees.

5. The display panel according to claim 1, wherein the display panel is a liquid crystal display panel, and the display panel body is a liquid crystal display panel body.

6. A display system, comprising:
a display panel comprising a display panel body, a first polarizer disposed on a non-display side of the display panel body, and a first wave plate disposed on a display side of the display panel body, wherein the display side is opposite to the non-display side; and
a pair of glasses comprising a second polarizer and a second wave plate, wherein the second polarizer comprises a polarizing layer, the second wave plate is disposed on a side of the polarizing layer away from eyes, and the pair of glasses is configured to present images displayed by the display panel.

7. The display system according to claim 6, wherein the first wave plate and the second wave plate are respectively a (½N+¼) wave plate and a (½M+¼) wave plate, and N and M are both positive integers.

8. The display system according to claim 7, wherein an acute angle between an absorption axis of the first polarizer and an optical axis of the first wave plate is greater than or equal to 40 degrees and less than or equal to 50 degrees.

9. The display system according to claim 7, wherein an acute angle between an absorption axis of the second polarizer and an optical axis of the second wave plate is greater than or equal to 40 degrees and less than or equal to 50 degrees.

10. The display system according to claim 7, wherein when the pair of glasses faces the display panel, an optical axis of the first wave plate and an optical axis of the second wave plate are perpendicular to each other, and an acute angle between the optical axis of the first wave plate and an absorption axis of the first polarizer is 45 degrees.

11. The display system according to claim 10, wherein when the pair of glasses faces the display panel, the absorption axis of the first polarizer is arranged in a first direction, an absorption axis of the second polarizer is arranged in a second direction, the first direction is perpendicular to the second direction, an angle between the optical axis of the first wave plate and the first direction is 45 degrees, and an angle between the optical axis of the second wave plate and the first direction is 135 degrees.

12. The display system according to claim 10, wherein when the pair of glasses faces the display panel, the absorption axis of the first polarizer is arranged in a first direction, an absorption axis of the second polarizer is arranged in a second direction, the first direction is perpendicular to the second direction, an angle between the optical axis of the first wave plate and the first direction is 135 degrees, and an angle between the optical axis of the second wave plate and the first direction is 45 degrees.

13. The display system according to claim 10, wherein when the pair of glasses faces the display panel, an absorption axis of the second polarizer is arranged in a first direction, the absorption axis of the first polarizer is arranged in a second direction, the first direction is perpendicular to the second direction, an angle between the optical axis of the first wave plate and the first direction is 45 degrees, and an angle between the optical axis of the second wave plate and the first direction is 135 degrees.

14. The display system according to claim 10, wherein when the pair of glasses faces the display panel, an absorption axis of the second polarizer is arranged in a first direction, the absorption axis of the first polarizer is arranged in a second direction, the first direction is perpendicular to the second direction, an angle between the optical axis of the first wave plate and the first direction is 135 degrees, and an angle between the optical axis of the second wave plate and the first direction is 45 degrees.

15. The display system according to claim 6, wherein the second wave plate is located in the second polarizer.

16. The display system according to claim 6, further comprising:
a first protective layer disposed on a side of the first wave plate away from the display panel body; and
a second protective layer disposed on a side of the second wave plate away from the polarizing layer of the second polarizer.

17. The display system according to claim 6, wherein an acute angle between an absorption axis of the first polarizer and an optical axis of the first wave plate is equal to 45 degrees.

18. The display system according to claim 6, wherein the first wave plate and the second wave plate are made of at least one of cyclic polyolefin and triacetate.

19. The display system according to claim 6, wherein the display panel is a liquid crystal display panel, and the display panel body is a liquid crystal display panel body.

20. The display system according to claim 19, wherein the liquid crystal display panel is a vertical alignment liquid crystal display panel or a fringe field switching liquid crystal display panel.
